(19) United States
(12) Patent Application Publication
(10) Pub. No.: US 2025/0384339 A1
(43) Pub. Date: Dec. 18, 2025

(54) METHODS AND SYSTEMS FOR TRAINING A MACHINE LEARNING MODEL FOR FINANCIAL SIMULATIONS

(71) Applicant: Credit Sesame, Inc., Mountain View, CA (US)

(72) Inventors: Adrian Nazari, Los Altos, CA (US); Pejman Makhfi, Los Gatos, CA (US); Rohan Kadakia, Palo Alto, CA (US); Deepak Sanem, Fremont, CA (US); Feng Zhao, El Paso, TX (US); Isaac Golberg, Thousand Oaks, CA (US); Mark Jarrell, Mountain View, CA (US)

(21) Appl. No.: 18/747,426

(22) Filed: Jun. 18, 2024

(51) Int. Cl. G06N 20/00; G06Q 40/03

(52) U.S. Cl. CPC G06N 20/00; G06Q 40/03

(57) ABSTRACT

Using various embodiments techniques to train a machine learning model to perform financial simulations are described herein. In one embodiment, this includes receiving a financial dataset that includes financial profiles of various consumers that includes features related to a financial condition of the consumers. A modeling dataset is constructed by associating a first and second credit profile of each consumer that reflects a change in the consumer's credit profile. Action(s) used to reflect this change are determined to define financial simulations. A target variable is constructed by subtracting a first credit profile feature from a second credit profile feature. A portion of the modeling dataset is reserved for evaluation purposes and the remainder is used to regress the target variable on a feature aggregated from the first credit profile with the action taken to result in the change. The model is then fine-tuned and evaluated on the reserved portion.

### FIELD OF THE INVENTION

Embodiments of the present invention generally relate to training Machine Learning (ML) models. More particularly, embodiments of the invention relate to training ML models that can assist in financial simulations.

### BACKGROUND OF THE INVENTION

A consumer's credit profile may be simulated for different reasons. One reason includes testing how different factors, such as income, expenses, credit history, and credit score, affect the consumer's ability to access credit products and services. For example, a lender might want to see how a consumer's credit profile changes after applying for a loan or a mortgage.

Another possible reason is to help the consumer understand their own credit profile and improve it over time. For example, a consumer might want to see how their credit score is calculated and what factors influence it. They might also want to learn how to improve their credit score by paying their bills on time, reducing their debt, and checking their credit reports regularly.

A consumer's credit profile can be simulated by using tools that can estimate how different actions, such as applying for a loan, paying off a balance, or changing the credit limit, might affect the consumer's credit score. As known to a person having ordinary skill in the art, a credit score is a numerical representation of the consumer's creditworthiness, based on various factors, such as payment history, credit utilization, length of credit history, types of credit, and new credit inquiries.

While conventional tools simulate a consumer's credit profile by use of predefined rules and algorithms to simulate a consumer's credit profile based on their personal information and financial data, they lack the ability to learn from historical data and predict patterns/future outcomes based on current inputs.

Therefore, methods, systems, and techniques are required that can generate ML models that can reliably simulate a consumer's credit profile.

### SUMMARY OF THE DESCRIPTION

Using various embodiments, systems, methods, and techniques are disclosed to train a Machine Learning (ML) model that can be used to accurately simulate a consumer's credit profile. In one embodiment, a system to train a machine learning model includes receiving a financial dataset that includes a financial profile of a set of consumers, the financial profile of at least one consumer from the set of consumers, including at least one feature related to a financial condition of the consumers. The system further includes constructing a modeling dataset by associating a first and second credit profile of the at least one consumer, where the first and second credit profiles refer to a change in the financial profile of the at least one consumer based on at least one action applied on the financial profile of the at least one consumer.

A set of financial simulations are defined based on the at least one action and for at least one financial simulation, a target variable is constructed for model supervision by subtracting a first credit profile feature from a second credit profile feature. A first portion of the modeling dataset is reserved for model evaluation purposes. Regressing, on a second portion of the modeling dataset, the target variable on the at least one feature aggregated from the first credit profile of the at least one consumer with the at least one action performed on the consumer's financial profile. In one embodiment, the at least one action can be performed or undertaken by the consumer. Thereafter, a trained model is constructed by fine-tuning the modeling dataset. In one embodiment, this can be performed by using a grid search and/or cross-validation. The trained model is then evaluated on the first portion of the modeling dataset.

In one embodiment, the financial profile comprises a credit score of each consumer. The credit score can be a Vantage score developed by the three national credit reporting companies, Experian, TransUnion and Equifax. In one embodiment, the first credit card profile can be the financial profile of the at least one consumer before the at least one action was undertaken and the second credit profile can be the financial profile of the at least one consumer after the at least one action was undertaken. In one embodiment, associating the first and second credit profiles includes pivoting the modeling dataset such that each row of the modeling dataset includes the first and second credit profiles of each consumer from the set of consumers. In one embodiment, regressing can include selecting a model of choice. In one embodiment, evaluating the trained model can include determining metric data, the metric data comprising at least one of Mean Absolute Error (MAE) or Mean Error (ME).

### BRIEF DESCRIPTION OF THE DRAWINGS

The present invention is illustrated by way of example and not limitation in the figures of the accompanying drawings in which like references indicate similar elements.

FIG. 1 is a block diagram illustrating the general components for training an ML model for financial simulations, in accordance with one embodiment of the invention.

FIG. 2 illustrates a flow chart describing the process of training an ML model for financial simulations, according to one embodiment of the present invention.

FIG. 3A illustrates an exemplary dataset with the financial/credit profiles of various consumers, according to one embodiment of the present invention.

FIG. 3B illustrates an exemplary modeling dataset with prior and posterior credit profiles, according to one embodiment of the present invention.

FIG. 4 illustrates an exemplary portion of a modeling dataset with prior and posterior credit profiles features, according to one embodiment of the present invention.

FIG. 5 illustrates an exemplary portion of a modeling dataset with target variables, according to one embodiment of the present invention.

FIG. 6 illustrates an exemplary portion of a modeling dataset with actions, according to one embodiment of the present invention.

FIG. 7 illustrates an exemplary portion of a modeling dataset with simulations and corresponding action sets, according to one embodiment of the present invention.

FIG. 8 is a block diagram illustrating a data processing system such as a computing system which may be used with one embodiment of the present invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” or “another embodiment” means that a particular feature, structure, or characteristic described in conjunction with the embodiment can be included in at least one embodiment of the invention. The appearances of the phrase “in one embodiment” in various places in the specification do not necessarily all refer to the same embodiment. The processes depicted in the figures that follow are performed by processing logic that comprises hardware (e.g., circuitry, dedicated logic, etc.), software, or a combination of both. Although the processes are described below in terms of some sequential operations, it should be appreciated that some of the operations described can be performed in a different order. Moreover, some operations can be performed in parallel rather than sequentially.

Various other systems, methods, or techniques disclosed in U.S. patent application Ser. No. ______, filed concurrently with the instant application, can be employed, in whole or in part, with the present invention to reliably simulate a consumer's credit profile. As a result, the above-identified disclosure is incorporated herein by reference in its entirety.

To assist in clarity of the invention “features” and “actions” as it relates to a consumer's credit profile are described herein. However, these should not be construed to be limiting the scope of the invention in any form or manner. In the event an ambiguity occurs as to the usage of any particular term, it should be construed broadly within the context provided herein.

Features, as described herein, refer to a distinct and quantifiable property of an observed event. Features are independent variables that can be numerical or structural and assist in effective pattern recognition, classification, and regression. In the context of credit profiles, features are the specific details from a person's credit history that can help predict their future behavior.

As a non-limiting example, a consumer's credit profile features can be their credit score, number of open credit card accounts, their total credit card utilization, total number of negative marks (e.g., delinquencies, foreclosures, collections, and/or bankruptcies) on their profile, number of days since the consumer opened their newest credit card account, total a balance on the consumer's loans, the loans including personal loans, auto-loans or mortgages of the consumer.

Actions, as described herein, refer to changes in a person's credit behavior. Broadly, an action is any deed, operation, activity, performance or undertaking that can affect a person's financial profile, credit score, or credit history. By studying these actions, a machine learning model, as described herein, can learn to predict how future actions might affect the consumer's credit profile/credit score. This can be useful for people who want to improve their credit score and need to know which actions will have the most impact.

As a non-limiting example, the actions that can be applied on a consumer's credit profile can include applying for a credit product, applying for a new personal loan, increasing or decreasing credit card balance, increasing or decreasing total credit utilization, resolving a negative mark on the financial profile, taking on a new delinquency, or a combination thereof. Actions can be performed or undertaken by the consumer or a third-party (e.g., lender).

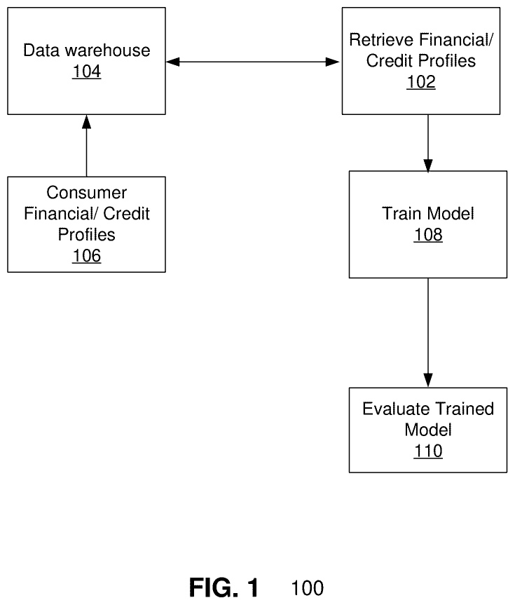

FIG. 1 is a block diagram 100 illustrating the general components for training an ML model for financial simulations, in accordance with one embodiment of the invention. As illustrated, 102 represents retrieving financial credit profiles of various consumers. In one embodiment, a computer system, represented by block 102, sends a request to data warehouse 104.

Computer 102 can interact with a data warehouse 104 to request data using various methods. In one embodiment, this interaction is made through an Application Programming Interface (API) or a Software Development Kit (SDK). An API provides a set of rules and protocols for software applications to interact with each other. In this context, in one embodiment, computer 102 sends a request to an API of data warehouse 104, which processes the request and returns the requested data. In one embodiment, the requested can be a set of consumer financial or credit profiles 106.

An SDK is a collection of software tools and libraries that developers use to create applications for specific platforms. Therefore, in one embodiment, an SDK for data warehouse 104 can include APIs and other tools needed for computer system 102 to interact with data warehouse 104.

In yet another embodiment, financial profiles 106 can also be retrieved through Structured Query Language (SQL) queries. Computer 102 can transmit SQL commands to data warehouse 104 to retrieve profiles 106. In one embodiment, data warehouse 104 can provide web-based interfaces or GUI (Graphical User Interface) tools that allows computer 102 to interact with data warehouse 104 to retrieve profiles 106.

Moreover, in one embodiment, JSON (JavaScript Object Notation) and/or XML (extensible Markup Language) can be used by computer 102 to request profiles 106 from data warehouse 104. In this embodiment, JSON/XML can be used to structure the data request sent to data warehouse 104. Data warehouse 104 can process the request and return the requested profiles 106 in the same format (JSON or XML) as originally requested by computer 102. In one embodiment, when requesting profiles 106, requests through JSON/XML are transmitted with RESTful APIs. In general, any technique known to a person having ordinary skill in the art can be used to retrieve profiles 106.

Block 108 represents the trained model, as described herein. Block 110 represents the evaluated trained model that can be deployed to perform various financial simulations on the financial profile of consumers whose financial information (e.g., credit scores, etc.) needs to be simulated.

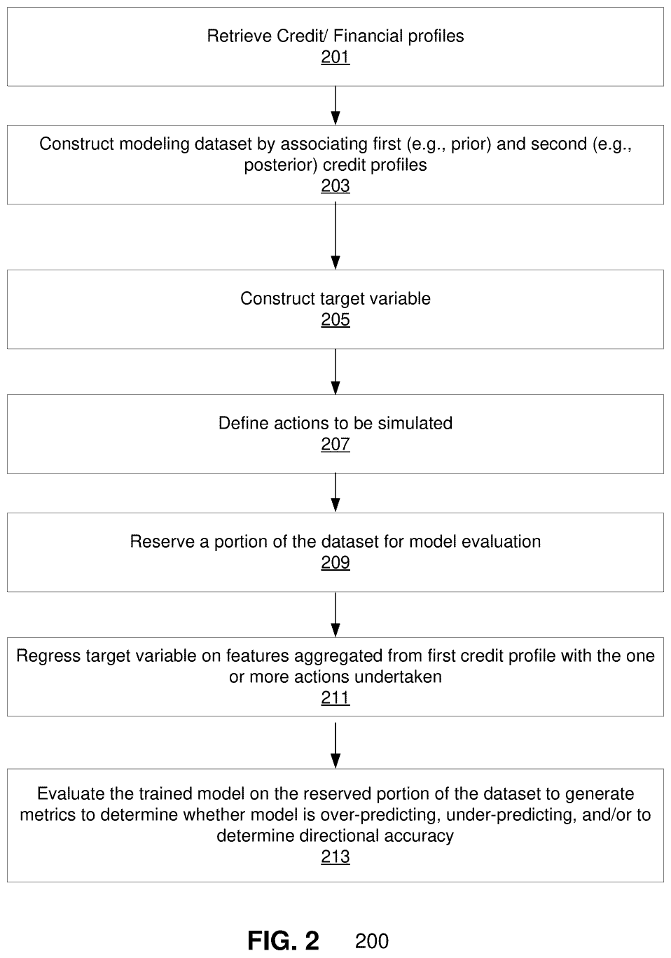

FIG. 2 illustrates flow chart 200 describing the process of training an ML model for financial simulations, according to one embodiment of the present invention. In one embodiment, at 201, a system implementing the techniques described herein, retrieves recent credit/financial profiles related to multiple consumers from a data warehouse. Each credit profile can include one or more credit profile features, as described herein. In one embodiment, the credit profile includes a Vantage3 credit score. In one embodiment, the credit score can range between a numerical range of 300 and 850. Thereafter, at 203, a modeling dataset is constructed by associating two credit profiles for each consumer, namely a prior credit profile and a posterior credit profile. As described herein, a prior credit profile signifies the consumer's financial profile before one or more actions were undertaken, and a posterior credit profile signifies the consumer's financial profile after the action(s) were undertaken.

In one embodiment, associating the prior and posterior credit profiles occurs either logically in memory or physically on disk. The association, in one embodiment, can be performed by pivoting the financial/credit profile of a consumer. In one embodiment, the pivoting involves arranging the prior and posterior credit profiles of a consumer (or a portion thereof) in a single row of a data-frame or any other data structure used to store the credit/financial profiles for processing the modeling dataset.

In one embodiment, the prior and posterior credit profile features includes at least one of credit score, number of credit card accounts, total credit card utilization, total number of negative marks (including at least one of delinquencies, foreclosures, collections or bankruptcies), number of days since the consumer opened their newest credit card account, total a balance on the consumer's loans, the loans including personal loans, auto-loans or mortgages of the consumer before and after the action(s) were undertaken, respectively.

Next, at 205, a target variable is constructed for model supervision. In one embodiment, this can be achieved by subtracting a prior credit profile feature (e.g., credit score) from its corresponding posterior credit profile feature. In embodiments where each row comprises the prior and posterior credit profiles of a consumer, the target variable is constructed by subtracting the feature row-wise for the consumer.

At 207, the action(s) that need to be simulated by a trained ML model are defined based on the raw information present in prior and posterior credit profiles. As a non-limiting example, in one embodiment, a simulation of ‘getting a new credit card’ can be defined as when: (a) there is a net increase of one (or more) in the number of open credit card accounts in the posterior profile of a consumer as compared with the prior profile and (b) when the consumer's total credit limit in the posterior profile exceeds their total credit limit in the prior profile. Therefore, each row in the final data-frame can correspond or be associated with one or more of the defined actions.

In one embodiment, the simulations can include: being denied for a credit product while sustaining a hard credit inquiry, getting a new credit card, getting a new personal loan, making a change in credit card balance, making a change in credit card utilization, resolving a negative mark (e.g., collection related event) on the credit profile, or taking on a new delinquency.

At 209, a first portion of the final dataset is reserved for model evaluation purposes. At 211, the target variable is regressed on features aggregated from the prior credit profile, together with the action or actions on a second portion of the final dataset. In one embodiment, the second portion can be the remainder of the modeling dataset subsequent to the reserving the first portion of the modeling dataset for evaluation purposes.

As known to a person having ordinary skill in the art, regression is a type of a predictive modelling technique that can estimates the relationship between a dependent (target) variable and one or more independent variables (features).

In one embodiment, in the context of credit profiles, the target variable that is regressed can be the change in a consumer's credit score. As a non-limiting example, in this embodiment, the features (or independent variables) can be the number of loans the consumer has taken out in the past, whether they have ever missed a payment, how long they have had credit for, etc. Similarly, as a non-limiting example, the action or actions could be operations like paying off a loan, opening a new credit card, etc.

Therefore, in one embodiment, at 211, the target variable (e.g., score change, etc.) can be regressed on various features and actions to predict how will those affect a consumer's financial profile. In the event the target variable is a change in a consumer's credit score, the model is requested to predict how much will the credit score change based on the selected features coupled with the selected actions.

The model of choice (for the purposes of regression) can be Linear Regression, Logistic Regression, Ridge Regression, Lasso Regression, Polynomial Regression, Bayesian Linear Regression, Support Vector Regression, Decision Tree Regression, Random Forest Regression, and Gradient Boosting Regression, or a combination thereof. In preferred embodiment, the model of choice includes using a Gradient Boosting Decision Tree that can be used for both regression and/or classification tasks.

In one embodiment, the model is trained using a process that involves hyperparameter tuning. Hyperparameter tuning refers to the process of finding the optimal values for parameters that control the behavior and performance of the ML model. Hyperparameters are set by the data scientist/developer before training, which allows fine tuning the model for optimal performance. The choice of hyperparameters can have a significant impact on model performance by affecting factors such as learning rate (the speed at which the model updates its parameters), number of hidden layers (the depth and complexity of the neural network), number of hidden units (the size and capacity of each neuron in each layer), batch size (the number of samples used in each iteration), etc. Some common approaches for hyperparameter tuning are:

Grid search: This approach involves defining a predefined grid or table with all possible combinations of hyperparameter values within a specified range for each hyperparameter. It then attempts all possible combinations using cross-validation and/or hold-out validation and selects those that perform best on a validation set.

Random search: This approach involves defining a predefined range for each hyperparameter value within which it will be randomly sampled from using probability distributions such as uniform distribution (equal probability for all values) or normal distribution (mean equal to median). It then attempts different combinations using cross-validation and/or hold-out validation and selects those that perform best on a validation set.

Bayesian optimization: This approach involves defining an objective function that measures how well a combination performs on a validation set using probability distributions such as Gaussian distribution (mean equal to median). It then uses an optimization algorithm such as simulated annealing or genetic algorithm to find an approximate solution that has high probability density in its objective function space.

In one embodiment, any of the hyperparameter tuning techniques described herein (or a combination thereof) can be implemented to train an ML model for use in financial simulations.

At 213, the trained model is evaluated on the dataset that was reserved at 209. In one embodiment, this includes evaluating include metrics (e.g., Mean Absolute Error (MAE), Mean Error (ME), etc.) to determine whether the trained model is over-predicting, under-predicting, and/or has directional accuracy.

In one embodiment, the training process includes determining the model's accuracy by residual analysis, cross-validation, regularization, or a combination thereof.

Residual Analysis is used to understand the difference between the actual and predicted values of the model, which can give insights into the model's errors. In this approach, the actual and predicted values of the target variable are compared. If the residuals (the differences between these values) are small and random, the model is likely predicting within an acceptable error range. However, large, correlated residuals suggest overfitting (over-predicting) or underfitting (under-predicting).

Cross-Validation is a technique for assessing how the results of a statistical analysis will generalize to an independent data set. It is mainly used in settings where the goal is prediction, and one wants to estimate how accurately a predictive model will perform in practice. This technique estimates the model's performance on new data. By splitting the data into subsets for training and testing, a more reliable measure of the model's accuracy can be determined.

Regularization is used to prevent overfitting of the model to the training data, which helps to improve the model's performance on new, unseen data. This approach adds a penalty term to the model's loss function to prevent extreme feature or weight values that could cause high prediction variance. Regularization techniques like L1 (lasso), L2 (ridge), elastic net, or a combination thereof can help reduce the issues arising from overfitting or underfitting predictions.

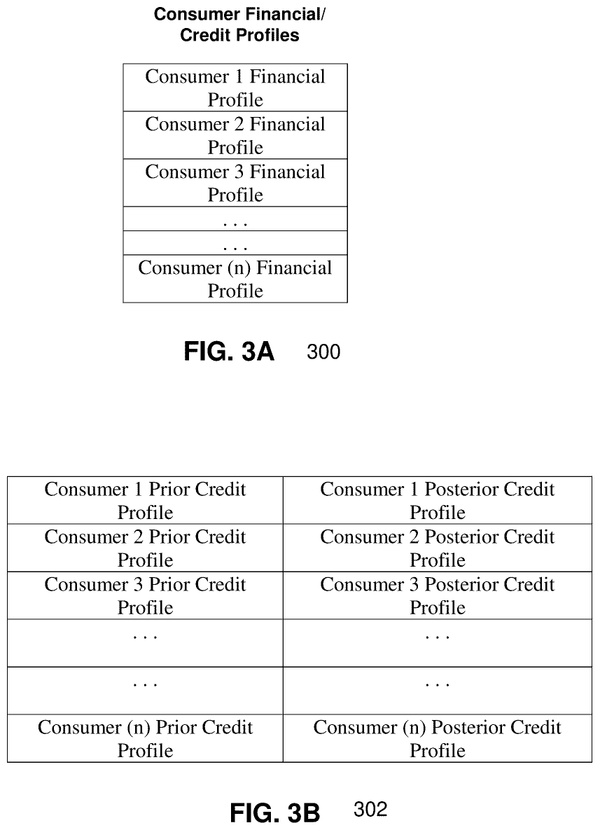

FIG. 3A illustrates an exemplary dataset 300 with the financial/credit profiles of various consumers, according to one embodiment of the present invention. In one embodiment, dataset 300 can be a portion of financial/credit profiles 106. As illustrated a set of (n) consumer financial profiles can be retrieved, where (n) represents any natural number. This set of consumer profiles can then be used to train an ML model, using the techniques described herein.

FIG. 3B illustrates an exemplary modeling dataset 302 with prior and posterior credit profiles, according to one embodiment of the present invention. As illustrated, in one embodiment, modeling dataset 302 can be constructed by associating the prior and posterior credit profiles of each consumer. The association, as illustrated, can be performed by pivoting the financial/credit profile of a consumer, where each row comprises the prior and posterior credit profiles.

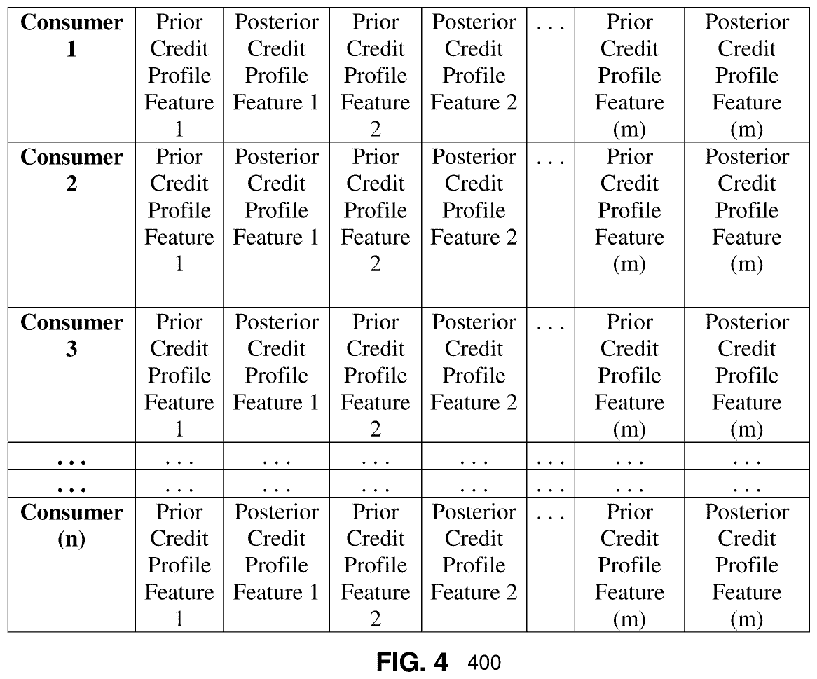

FIG. 4 illustrates an exemplary portion 400 of a modeling dataset with prior and posterior credit profiles features, according to one embodiment of the present invention. As illustrated, each consumer in the set of (n) consumers can have a set of (m) features, where (m) represents a natural number. In the exemplary embodiment illustrated, features from the prior and posterior credit profiles can be presented in a data-frame that can be used to train an ML model, using the techniques described herein. While exemplary portion 400 of modeling dataset shows all features from 1 through (m) available for each of the (n) consumers, in practice, this does not need to be the case. In other words, one or more consumers can have a unique set of (m) features.

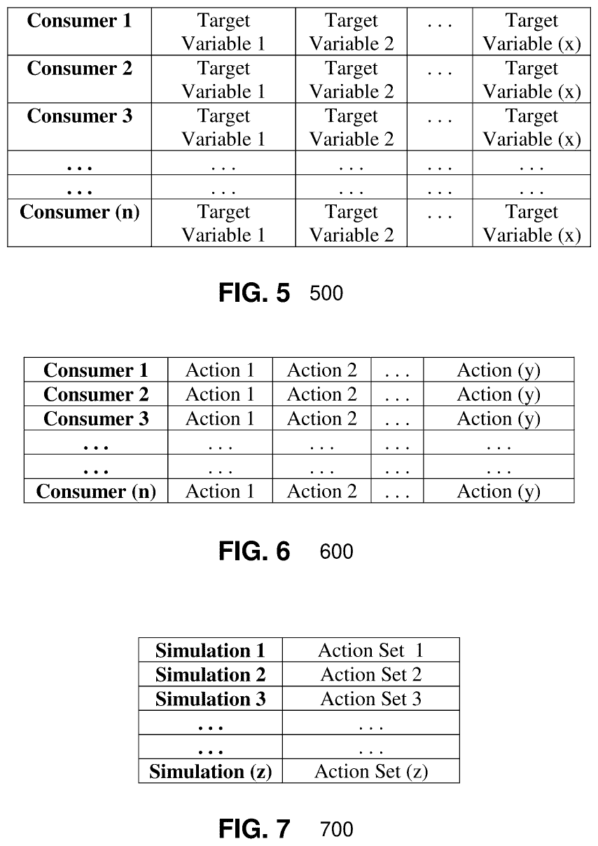

FIG. 5 illustrates an exemplary portion 500 of a modeling dataset with target variables, according to one embodiment of the present invention. As illustrated, a set of (x) target variables can be constructed for each consumer based on the set of features available in that consumer's credit/financial profile, where (x) represents a natural number. While exemplary portion 500 of modeling dataset shows all target variables, from 1 through (x), available for each of the (n) consumers, in practice, this does not need to be the case. In other words, one or more consumers can have a unique set of (x) target variables.

FIG. 6 illustrates an exemplary portion 600 of a modeling dataset with actions, according to one embodiment of the present invention. As illustrated, a set of (y) actions can be identified for each consumer based on the set of target variables and/or features available in that consumer's credit/financial profile, where (y) represents a natural number. While exemplary portion 600 of modeling dataset shows all actions, from 1 through (y), available for each of the (n) consumers, in practice, this does not need to be the case. In other words, one or more consumers can have a unique set of (y) actions identified from their credit profile.

FIG. 7 illustrates an exemplary portion 700 of a modeling dataset with defined financial simulations and corresponding action sets, according to one embodiment of the present invention. As illustrated, a set of (z) action sets can be defined for a corresponding financial simulation, where (z) represents a natural number. Each simulation can include one or more identified actions to represent its corresponding action set, as described herein.

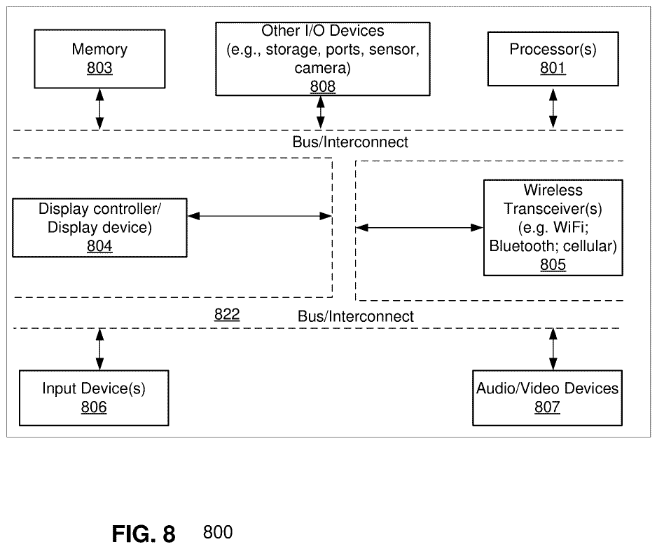

FIG. 8 is a block diagram 800 illustrating a data processing system such as a computing system 800 which may be used with one embodiment of the present invention. For example, system 800 can be implemented as part of any aspect of the current invention (e.g., transaction transfer algorithm). It should be apparent from this description that aspects of the present invention can be embodied, at least in part, in software. That is, the techniques may be carried out in a computer system or other computer system in response to its processor, such as a microprocessor, executing sequences of instructions contained in memory, such as a ROM, DRAM, mass storage, or a remote storage device. In various embodiments, hardware circuitry may be used in combination with software instructions to implement the present invention. Thus, the techniques are not limited to any specific combination of hardware circuitry and software nor to any particular source for the instructions executed by the computer system. In addition, throughout this description, various functions and operations are described as being performed by or caused by software code to simplify description. However, those skilled in the art will recognize what is meant by such expressions is that the functions result from execution of the code by a processor.

In one embodiment, system 800 can represent a computing system implementing the techniques described herein. System 800 can have a distributed architecture having a plurality of nodes coupled through a network, or all of its components may be integrated into a single unit. Computing system 800 can represent any of the data processing systems described above performing any of the processes or methods described above. In one embodiment, computer system 800 can be implemented as integrated circuits (ICs), discrete electronic devices, modules adapted to a circuit board such as a motherboard, an add-in card of the computer system, and/or as components that can be incorporated within a chassis/case of any computing device. System 800 is intended to show a high level view of many components of any data processing unit or computer system. However, it is to be understood that additional or fewer components may be present in certain implementations and furthermore, different arrangement of the components shown may occur in other implementations. System 800 can represent a desktop, a laptop, a tablet, a server, a mobile phone, a programmable logic controller, a personal digital assistant (PDA), a personal communicator, a network router or hub, a wireless access point (AP) or repeater, a set-top box, or a combination thereof.

In one embodiment, system 800 includes processor 801, memory 803, and devices 805-808 via a bus or an interconnect 822. Processor 801 can represent a single processor or multiple processors with a single processor core or multiple processor cores included therein. Processor 801 can represent one or more general-purpose processors such as a microprocessor, a central processing unit (CPU), Micro Controller Unit (MCU), etc. Processor 801 can be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 801 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions. Processor 801, can also be a low power multi-core processor socket such as an ultra low voltage processor, may act as a main processing unit and central hub for communication with the various components of the system. Such processor can be implemented as a system on chip (SoC).

Processor 801 is configured to execute instructions for performing the operations and methods described herein. System 800 further includes a graphics interface that communicates with graphics subsystem 804, which may include a display controller and/or a display device. Processor 801 can communicate with memory 803, which in an embodiment can be implemented via multiple memory devices to provide for a given amount of system memory. In various implementations the individual memory devices can be of different package types such as single die package (SDP), dual die package (DDP) or quad die package (QDP). These devices can in some embodiments be directly soldered onto a motherboard to provide a lower profile solution, while in other embodiments the devices can be configured as one or more memory modules that in turn can couple to the motherboard by a given connector. Memory 803 can be a machine readable non-transitory storage medium such as one or more volatile storage (or memory) devices such as random access memory (RAM), dynamic RAM (DRAM), synchronous DRAM (SDRAM), static RAM (SRAM), or other types of storage devices such as hard drives and flash memory. Memory 803 may store information including sequences of executable program instructions that are executed by processor 801, or any other device. System 800 can further include IO devices such as devices 805-808, including wireless transceiver(s) 805, input device(s) 806, audio IO device(s) 807, and other IO devices 808.

Wireless transceiver 805 can be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, network interfaces (e.g., Ethernet interfaces) or a combination thereof. Input device(s) 806 can include a mouse, a touch pad, a touch sensitive screen (which may be integrated with display device 804), a pointer device such as a stylus, and/or a keyboard (e.g., physical keyboard or a virtual keyboard displayed as part of a touch sensitive screen). Other optional devices 808 can include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Optional devices 808 can further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors can be coupled to interconnect 822 via a sensor hub (not shown), while other devices such as a keyboard or thermal sensor may be controlled by an embedded controller (not shown), dependent upon the specific configuration or design of system 800.

To provide for persistent storage of information such as data, applications, one or more operating systems and so forth, in one embodiment, a mass storage (not shown) may also couple to processor 801. In various embodiments, to enable a thinner and lighter system design as well as to improve system responsiveness, this mass storage may be implemented via a solid state device (SSD). However in other embodiments, the mass storage may primarily be implemented using a hard disk drive (HDD) with a smaller amount of SSD storage to act as a SSD cache to enable non-volatile storage of context state and other such information during power down events so that a fast power up can occur on RE-initiation of system activities. Also a flash device may be coupled to processor 801, e.g., via a serial peripheral interface (SPI). This flash device may provide for non-volatile storage of system software, including a basic input/output software (BIOS) as well as other firmware of the system.

Note that while system 800 is illustrated with various components of a data processing system, it is not intended to represent any particular architecture or manner of interconnecting the components; as such details are not germane to embodiments of the present invention. It will also be appreciated that network computers, handheld computers, mobile phones, and other data processing systems which have fewer components or perhaps more components may also be used with embodiments of the invention.

Thus, methods, apparatuses, and computer readable medium to implement the techniques as described herein. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

1. A method of training a machine learning model, comprising:
receiving, by a computing device, a financial dataset, wherein the financial dataset includes a financial profile of a set of consumers, the financial profile of at least one consumer from the set of consumers including at least one feature related to a financial condition of the at least one consumer;
constructing a modeling dataset by associating a first and second credit profile of the at least one consumer, the first and second credit profiles referring to a change in the financial profile of the at least one consumer based on at least one action applied on the financial profile of the at least one consumer;
defining at least one financial simulation based on the at least one action;
for the at least one financial simulation, constructing a target variable for model supervision by subtracting a first credit profile feature from a second credit profile feature;
reserving a first portion of the modeling dataset for model evaluation purposes;
regressing, on a second portion of the modeling dataset, the target variable on the at least one feature aggregated from the first credit profile of the at least one consumer with the at least one action;
constructing a trained model by fine-tuning the modeling dataset using a grid search and cross-validation; and
evaluating the trained model on the first portion of the modeling dataset.

2. The method of claim 1, wherein the financial profile comprises a credit score of each consumer.

3. The method of claim 2, wherein the credit score is a vantage score developed by national credit reporting companies.

4. The method of claim 1, wherein the first credit card profile is the financial profile of the at least one consumer before the at least one action was undertaken, and wherein the second credit profile is the financial profile of the at least one consumer after the at least one action was undertaken.

5. The method of claim 1, wherein the associating includes pivoting the modeling dataset such that each row of the modeling dataset includes the first and second credit profiles of each consumer from the set of consumers.

6. The method of claim 1, wherein the regressing includes selecting a model of choice.

7. The method of claim 1, wherein the evaluating includes determining metric data, the metric data comprising at least one of Mean Absolute Error (MAE) or Mean Error (ME), and wherein the metric data signifies whether the trained model is over-predicting, under-predicting, or has directional accuracy.

8. A non-transitory computer readable medium comprising instructions which when executed by a processor implements a method of training a machine learning model, comprising:
receiving a financial dataset, wherein the financial dataset includes a financial profile of a set of consumers, the financial profile of at least one consumer from the set of consumers including at least one feature related to a financial condition of the at least one consumer;
constructing a modeling dataset by associating a first and second credit profile of the at least one consumer, the first and second credit profiles referring to a change in the financial profile of the at least one consumer based on at least one action applied on the financial profile of the at least one consumer;
defining at least one financial simulation based on the at least one action;
for the at least one financial simulation, constructing a target variable for model supervision by subtracting a first credit profile feature from a second credit profile feature;
reserving a first portion of the modeling dataset for model evaluation purposes;
regressing, on a second portion of the modeling dataset, the target variable on the at least one feature aggregated from the first credit profile of the at least one consumer with the at least one action;
constructing a trained model by fine-tuning the modeling dataset using a grid search and cross-validation; and
evaluating the trained model on the first portion of the modeling dataset.

9. The non-transitory computer readable medium of claim 8, wherein the financial profile comprises a credit score of each consumer.

10. The non-transitory computer readable medium of claim 9, wherein the credit score is a vantage score developed by national credit reporting companies.

11. The non-transitory computer readable medium of claim 8, wherein the first credit card profile is the financial profile of the at least one consumer before the at least one action was undertaken, and wherein the second credit profile is the financial profile of the at least one consumer after the at least one action was undertaken.

12. The non-transitory computer readable medium of claim 8, wherein the associating includes pivoting the modeling dataset such that each row of the modeling dataset includes the first and second credit profiles of each consumer from the set of consumers.

13. The non-transitory computer readable medium of claim 8, wherein the regressing includes selecting a model of choice.

14. The non-transitory computer readable medium of claim 8, wherein the evaluating includes determining metric data, the metric data comprising at least one of Mean Absolute Error (MAE) or Mean Error (ME), and wherein the metric data signifies whether the trained model is over-predicting, under-predicting, or has directional accuracy.

15. A system of training a machine learning model comprising:
a memory device;
a processor coupled to the memory device, the processor configured to:
receive a financial dataset, wherein the financial dataset includes a financial profile of a set of consumers, the financial profile of at least one consumer from the set of consumers including at least one feature related to a financial condition of the at least one consumer;
construct a modeling dataset by associating a first and second credit profile of the at least one consumer, the first and second credit profiles referring to a change in the financial profile of the at least one consumer based on at least one action applied on the financial profile of the at least one consumer;
define at least one financial simulation based on the at least one action;
for the at least one financial simulation, construct a target variable for model supervision by subtracting a first credit profile feature from a second credit profile feature;
reserve a first portion of the modeling dataset for model evaluation purposes;
regress, on a second portion of the modeling dataset, the target variable on the at least one feature aggregated from the first credit profile of the at least one consumer with the at least one action;
construct a trained model by fine-tuning the modeling dataset using a grid search and cross-validation; and
evaluate the trained model on the first portion of the modeling dataset.

16. The system of claim 15, wherein the financial profile comprises a credit score of each consumer.

17. The system of claim 16, wherein the credit score is a vantage score developed by national credit reporting companies.

18. The system of claim 15, wherein the first credit card profile is the financial profile of the at least one consumer before the at least one action was undertaken, and wherein the second credit profile is the financial profile of the at least one consumer after the at least one action was undertaken.

19. The system of claim 15, wherein the associating includes pivoting the modeling dataset such that each row of the modeling dataset includes the first and second credit profiles of each consumer from the set of consumers.

20. The system of claim 15, wherein the regress includes selecting a model of choice, and wherein the evaluating includes determining metric data, the metric data comprising at least one of Mean Absolute Error (MAE) or Mean Error (ME), and wherein the metric data signifies whether the trained model is over-predicting, under-predicting, or has directional accuracy.
